(19) United States
(12) Patent Application Publication
(10) Pub. No.: US 2023/0354917 A1
(43) Pub. Date: Nov. 9, 2023

(54) AEROSOL-GENERATING DEVICE OPERABLE IN AN AEROSOL-RELEASING MODE AND IN A PAUSE MODE

(71) Applicant: Philip Morris Products S.A., Neuchatel (CH)

(72) Inventors: Yannick BUTIN, Neuchatel (CH); Enrico STURA, Neuchatel (CH); Ezequiel VALDEZ ROJAS, Lausanne (CH); Milica NESOVIC, Neuchatel (CH); Valerio OLIANA, Lausanne (CH); Daniela HAU, Neuchatel (CH)

(73) Assignee: Philip Morris Products S.A., Neuchatel (CH)

(21) Appl. No.: 18/042,645

(22) PCT Filed: Aug. 30, 2021
(86) PCT No.: PCT/EP2021/073846

§ 371 Date: Feb. 23, 2023

(30) Foreign Application Priority Data
Sep. 1, 2020 (EP) 20193921.2

(51) Int. Cl. A24F 40/20; A24F 40/60; A24F 40/57; A24F 40/51; H05B 1/02

(52) U.S. Cl. CPC A24F 40/57; A24F 40/20; A24F 40/51; A24F 40/60; H05B 1/0244

(57) ABSTRACT

An aerosol-generating device is provided, including: an electrical heating arrangement configured to heat an aerosol-forming substrate in order to generate an aerosol; at least one of a user switch to enable a user to initiate a use pause of the device, and at least one sensor to output a sensor signal indicative of the device being in use by the user or in the use pause; and a controller to generate a pause signal in response to the sensor signal indicating that the device is in the use pause and/or in response to the user initiating the use pause of the device via the user switch, the heating arrangement being further configured to heat the substrate at a first temperature level in an aerosol-releasing mode, and in response to the pause signal to heat the substrate at a second temperature level below the first temperature level in a pause mode.

The present disclosure relates to an aerosol-generating device and an aerosol-generating system for heating an aerosol-forming substrate that is capable to form an inhalable aerosol when heated. The disclosure further relates to a method of operating such an aerosol-generating device.

Aerosol-generating devices for generating inhalable aerosols by electrically heating aerosol-forming substrates that are capable to form an aerosol when heated are generally known from prior art. Such devices may comprise a cavity for removably receiving at least a portion of an aerosol-generating article that includes the aerosol-forming substrate to be heated. The devices further comprise an electrical heating arrangement for heating the substrate, when the article is received in the cavity. For aerosol generation, the substrate has to be heated up to an operating temperature sufficient to allow volatile compounds to be released from the substrate. Once started, a user experience typically is continued without ceasing until the aerosol-forming substrate in the article is depleted. Nevertheless, there is a users’ desire to be able to interrupt a user experience and to resume the experience at a later stage with the same article, preferably until fully depleting the substrate. However, a user experience – once having been interrupted –may often be resumed only with degraded quality of the aerosol generated from the non-depleted substrate.

Therefore, it would be desirable to have an aerosol-generating device and a method of operating such a device with the advantages of prior art solutions, whilst mitigating their limitations. In particular, it would be desirable to have an aerosol-generating device and a method of operating such a device allowing a user to interrupt a user experience and to resume the experience at a later stage with still acceptable quality of the aerosol.

According to the present invention, there is provided an aerosol-generating device comprising an electrical heating arrangement for heating an aerosol-forming substrate in order to generate an aerosol. The heating arrangement is configured to heat the aerosol-forming substrate at a first temperature level in an aerosol-releasing mode. The heating arrangement is further configured – in response to a pause signal – to heat the aerosol-forming substrate at a second temperature level below the first temperature level in a pause mode.

According to the invention, it was found that a user experience may be interrupted and resumed at a later stage when the aerosol-forming substrate is kept in pause mode of the heating arrangement at a temperature below the first temperature level used during normal use of the device (in particular during a user experience), but still well above room temperature. That is, the second temperature level preferably is chosen such as to avoid degradation of the non-depleted substrate. In particular, the second temperature level is chosen such as to be sufficiently low in order to minimize depletion of the substrate during the pause mode, and at the same time to be sufficiently high in order to avoid vapor to condensate in the device which otherwise could affect the quality of the non-depleted aerosol-forming substrate. In other words, during use of the device, in particular when a user experience is to take place, the heating arrangement is operated in the aerosol-releasing mode, whereas during a use pause of the device, that is, when no user experience is to take place, the heating arrangement is operated in the pause mode. During both, the aerosol-releasing mode and the pause mode of the heating arrangement, the heating arrangement is in operation, in particular in heating operation, yet at different temperature levels, namely, at a first temperature level during the aerosol-releasing mode, which is chosen to be sufficiently high in order to generate an aerosol, and at a second temperature level below the first temperature level during the pause mode, which is chosen to be sufficiently low in order to minimize depletion of the substrate, whilst avoiding degradation.

Depending on the type and composition of the specific aerosol-forming substrate to be used with the device, the first temperature level may be in a range between 325 degree C and 385 degree C, particularly between 340 degree C and 370 degree C, more particularly between 350 degree C and 360 degree C. These temperatures are suitable operating temperatures sufficient to allow volatile compounds to be released from the aerosol-forming substrate. For example, the first temperature level for liquid aerosol-forming substrates may be lower than the first temperature level for solid aerosol forming substrates.

In general, the second temperature level is chosen to maintain a usability of the aerosol-releasing substrate for a prolonged time. The second temperature level may also depend on the type and composition of the aerosol-forming substrate to be used with the device. Accordingly, the second temperature level may be in a range between 175 degree C and 225 degree C, particularly between 185 degree C to 215 degree C, more particularly between 195 degree C and 205 degree C. These temperatures are sufficiently low in order to minimize depletion of the substrate during the pause mode but at the same time sufficiently high in order to avoid vapor to condensate in the device.

In order to avoid condensation effects in the device, in particular to avoid condensation of substances in the aerosol-forming substrate, the second temperature level may be at least 150 degree C, in particular at least 175 degree C, preferably at least 185 degree C, more preferably at least 195 degree C.

Vice versa, in order to minimize depletion of the substrate during the pause mode the second temperature level may be at most 220 degree C, in particular at most 225 degree C, preferably at most 215 degree C, more preferably at least 205 degree C. In particular, the second temperature level may be chosen such as to reduce the formation of aerosols by at least 50 percent.

In relative terms, the second temperature level may be lower than the first temperature level by at least 50 degree C, in particular at least 75 degree C, more particularly at least 100 degree C.

The temperature values given above preferably are average temperatures of the aerosol-forming substrate during operation of the device. In addition, as already mentioned, the temperature values may depend – inter alia – on the type and composition of the aerosol-forming substrate to be used with the device.

As used herein, the pause mode refers to a first operational mode of the heating arrangement in which the heating arrangement is operated during an operation pause, that is, a use pause of the aerosol-generating device, that is, when a user experience is paused and aerosol generation is not to take place, or at least is to be reduced to a minimum level. That is, in the pause mode the aerosol-generating device in is a use pause.

Vice versa, the aerosol-releasing mode refers to a second operational mode of the heating arrangement, which is the normal heating operational mode of the heating arrangement for aerosol generation, in which the heating arrangement is operated during use of the device by a user, that is, when a user experience takes place, in particular when aerosol generation takes place. In general aerosol generation may take place continuously or on demand, in particular on a puff basis, that is, on demand of a user when taking a puff.

The aerosol-generating device may comprise at least one sensor configured to output a sensor signal indicative of the device being in operation by a user, that is, in use by a user, or in an operation pause, that is, a use pause. Advantageously, such a sensor may facilitate to automatically detect whether operation of the heating arrangement can be switched into the pause mode since the device is currently not in use and thus in an operation pause that is, a use pause. Thus, aerosol generation may be stopped in a timely manner in order to avoid an ongoing but undesired depletion of the aerosol-forming substrate. Likewise, such a sensor may facilitate to automatically detect whether operation of the heating arrangement is to be switched back into the aerosol-releasing mode, that is, back into the normal heating operational mode for aerosol generation when a user wants to resume a user experience.

The at least one senor may comprise one of a puff sensor for detecting a user’s puff, a motion sensor for detecting a movement of the device, and an orientation sensor for detecting an orientation of the device. A puff sensor advantageously allows for detecting normal operation of the device, in particular the beginning or resumption of a user experience. A motion sensor advantageously may enable to monitor the device for movements and thus, for example, to detect a user handling the device. That is, if the motion sensor detects any movements of the aerosol-generating device, this may indicate that a user is holding the device and therefore probably is currently having a user experience or about to start or resume a user experience. For example, the motion sensor may detect movements of the aerosol-generating device when the device is picked up again after lying on a table. If no movements are detected, this typically means that the aerosol-generating device is in an idle phase. This might be the case, when the aerosol-generating device is placed in a power charging unit or is lying idle on a table. Consequently, the heating arrangement may be switched into the pause mode in order to avoid degradation of the non-depleted substrate.

As an example, the motion sensor may comprise at least one of an accelerometer for measuring accelerations or a gyroscope for measuring an angular orientation or an angular velocity of the device. That is, the motion sensor may be configured to detect at least one of accelerations, an angular orientation and or an angular velocity of the aerosol-generating device, in particular due to a user handling the device. Likewise, an orientation sensor may be used for detecting an orientation of the device which in turn may be indicative for a specific situation. For example, a horizontal orientation of the device (for example, with respect to a length axis of the aerosol-generating device) may be indicative of the device lying idle on a table. Likewise, a vertical orientation of the device or an orientation of the device between a vertical orientation and a horizontal orientation may be indicative of the device being in use during a user experience.

It is possible that the aerosol-generating device comprise a single sensor or a plurality of sensors, in particular a plurality of sensors of different types. A plurality of sensors may be provided, for example, for reasons of redundancy. Using a plurality of sensors of different types may also facilitate to detect different situations. In particular, the device may comprise at least one sensor configured to output a sensor signal indicative of the device being in operation by user, that is, in use by a user, and at least one other sensor configured to output a sensor signal indicative of the device being in an operation pause.

In addition or alternative to the at least one sensor, the aerosol-generating device may comprise a user switch enabling a user of the device to initiate at least one of operation of the device, in particular in order to initiate use of the device, in particular a user experience, that is to initiate aerosol generation, or an operation pause, that is, a use pause, in particular in order to stop aerosol generation (temporarily). The user switch may be part of a user interface of the device. Such a user interface may also be configured to indicate the actual operational mode of the aerosol-generating device. For this, the user interface may comprise, for example, a display or one or more light sources, such as one or more LEDs (Light Emitting Diodes).

The aerosol-generating device may further comprise a controller configured to generate the pause signal in response to at least one of the sensor signal indicating an operation pause, that is, a use pause, or a user initiating an operation pause, that is, a use pause via the user switch. The pause signal may be received by the heating arrangement in order to initiate the pause mode. In particular, the controller may be configured to generate the pause signal in response to a motion sensor detecting for a predetermined idle time movements of the device not reaching a pre-determined motion threshold or in response to a motion sensor detecting for a predetermined idle time no movements. The idle time may be in a range between 10 seconds and 90 seconds, in particular between 15 seconds and 60 seconds, preferably between 15 seconds and 40 seconds. The pre-determined motion threshold may be defined by an acceleration value, or angular value or an angular velocity value. Preferably, the pre-determined acceleration threshold is in a range between 0.5 g and 1.5 g, in particular between 0.7 g and 1.3 g, wherein g denotes the standard acceleration due to gravity which is defined by standard as 9.80665 m/s2 [meter per square second].

Furthermore, the controller may be configured to generate an activity signal in response to the sensor signal indicating operation of the device and/or in response to a user initiating operation of the device via the user switch. Likewise, the activity signal may be received by the heating arrangement in order to initiate the aerosol-releasing mode. In particular, the controller may be configured to generate an activity signal in response to a motion sensor detecting movement of the device reaching or exceeding a pre-determined motion threshold. Again, the pre-determined motion threshold may be defined by an acceleration value, or angular value or an angular velocity value. As defined above, the pre-determined acceleration threshold may be in a range between 0.5 g and 1.5 g, in particular between 0.7 g and 1.3 g, wherein g denotes the standard acceleration due to gravity which is defined by standard as 9.80665 m/s2 [meter per square second].

In general, the controller may be configured to control the overall operation of the aerosol-generating device. In particular, controller may be configured to control the heating process, preferably in a closed-loop configuration, in particular for controlling heating of the aerosol-forming substrate at the respective temperature levels.

The controller may be or may comprise a main control unit (MCU) of the aerosol-generating device. The controller may comprise a microprocessor, for example a programmable microprocessor, a microcontroller, or an application specific integrated chip (ASIC) or other electronic circuitry capable of providing control. In particular, the heating arrangement may – at least partially – be part of the controller.

The heating arrangement may be configured to change from the pause mode to the aerosol-releasing mode after elapse of a predetermined maximum pause time or in response to the activity signal. In particular, the heating arrangement may be configured to change from the pause mode to the aerosol-releasing mode after elapse of a predetermined maximum pause time or in response to the activity signal, depending on which event occurs earlier. Advantageously, this prevents a subsequently resumed user experience from being still impaired due to keeping the aerosol-forming substrate for an excessively long time period in the pause mode. The predetermined maximum pause time may be in a range between 1 minute to 15 minutes, in particular between 2 minutes and 14 minutes, more particularly between 3 minutes and 5 minutes or between 7 minutes and 12 minutes. These maximum pause times ensure that the aerosol-forming substrate is sufficiently prevented from degradation.

Likewise, the heating arrangement may be configured to stop (heating) operation, that is, to stop any operation in both the aerosol-releasing mode and the pause mode, after at least one of
a predetermined number of puffs,
elapse of a predetermined operation time in the aerosol-releasing mode,
elapse of a predetermined operation time in the pause mode; and
elapse of a predetermined weighted cumulative operation time in the aerosol-releasing mode and the pause mode.

Using a weighted cumulative operation time advantageously may take into account that the aerosol-forming substrate might get still be slightly depleted during the pause mode which reduces the effective operation time in the aerosol-releasing mode. As an example, time in the aerosol-releasing mode may be weighted with a factor of 1, whereas the time in the pause mode may be weighted with a factor of ⅙. Accordingly, in case the effective operation time of a given aerosol-generating article for realizing a still acceptable amount of aerosol is, for example, 6 minutes, the device may be operated may be operated either for 6 minutes in the aerosol-releasing mode or for 0 minutes in the pause mode, or for 5 minutes in the aerosol-releasing mode or for 6 minutes in the pause mode, or for 4 minutes in the aerosol-releasing mode or 12 minutes in the pause mode, and so on. That is, valid time pairs for overall operation in the aerosol-releasing mode and the pause mode may be 6 minutes and 0 minutes, or 5 minutes and 6 minutes, or 4 minutes and 12 minutes, and so on.

The predetermined operation time in the aerosol-releasing mode may be in a range between 1 minute to 12 minutes, in particular between 2 minutes and 10 minutes, more particularly between 3 minutes and 8 minutes, for example 6 minutes.

Likewise, the predetermined operation time in the pause mode may be in a range between 1 minute to 15 minutes, in particular between 2 minutes and 14 minutes, more particularly between 5 minutes and 13 minutes, for example 12 minutes.

The predetermined weighted cumulative operation time in the aerosol-releasing mode and the pause mode may be in a range between 1 minute to 12 minutes, in particular between 2 minutes and 10 minutes, more particularly between 3 minutes and 8 minutes, for example 6 minutes. The factor for weighting the time in the aerosol-releasing mode preferably is equal to 1. The factor for weighting the time in the in the pause mode may be in a range between ⅒ and ½, in particular between ⅛ and ½ or between ¼ and ½, for example ⅙.

Depending on the type, composition and volume of the aerosol-forming substrate to be used with the device, the predetermined number of puffs may be in a range between 5 and 400, in particular between 5 and 250, more particularly between 5 and 100, preferably between 5 and 20, more preferably between 5 and 15, for example between 10 and 14.

The heating arrangement may be configured to change from heating at the first temperature level in the aerosol-releasing mode to heating at the second temperature level in the pause mode in response to the pause signal by stopping heating the aerosol-forming substrate until the second temperature level is reached or by heating the aerosol-forming substrate with reduced heating power or in a pulsed mode until the second temperature level is reached. In particular, the heating arrangement may be configured to change from heating at the first temperature level to heating at the second temperature level via a cooling mode in which the heating arrangement is configured to stop heating the aerosol-forming substrate until the second temperature level is reached or to heat the aerosol-forming substrate with reduced heating power or in a pulsed mode until the second temperature level is reached. The cooling mode may be part of the pause mode, in particular an initial part of the pause mode. It is also possible that the cooling mode is a separate operational mode between the aerosol-releasing mode and the pause mode.

As used herein, the term “aerosol-forming substrate” denotes a substrate formed from or comprising an aerosol-forming material that is capable of releasing volatile compounds upon heating for generating an aerosol. The aerosol-forming substrate is intended to be heated rather than combusted in order to release the aerosol-forming volatile compounds. The aerosol-forming substrate may be a solid aerosol-forming substrate, a liquid aerosol-forming substrate, a gel-like aerosol-forming substrate, or any combination thereof. The aerosol-forming substrate may comprise a tobacco-containing material containing volatile tobacco flavor compounds, which are released from the substrate upon heating. Alternatively or additionally, the aerosol-forming substrate may comprise a non-tobacco material. The aerosol-forming substrate may further comprise an aerosol former. Examples of suitable aerosol formers are glycerin and propylene glycol. The aerosol-forming substrate may also comprise other additives and ingredients, such as nicotine or flavourants. The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

The aerosol-forming substrate to be heated may be part of an aerosol-generating article to be engaged with or to be received by, in particular in the aerosol-generating device in order to heat the aerosol-forming substrate contained in the aerosol-generating article. As used herein, the term “aerosol-generating article” refers to an article comprising at least one aerosol-forming substrate that is capable to release volatile compounds that can form an aerosol. Preferably, the aerosol-generating article is a heated aerosol-generating article. That is, an aerosol-generating article which comprises at least one aerosol-forming substrate that is intended to be heated rather than combusted in order to release volatile compounds that can form an aerosol. The aerosol-generating article may be a consumable, in particular a consumable to be discarded after a single use. For example, the article may be a cartridge including a liquid or gel-like aerosol-forming substrate to be heated. As another example, the article may be a rod-shaped article, in particular a tobacco article, resembling conventional cigarettes which includes a solid tobacco containing aerosol-forming substrate.

The aerosol-generating device may comprise a cavity for removably receiving at least a portion of the aerosol-forming substrate to be heated, in particular for removably receiving at least a portion of an aerosol-generating article comprising the aerosol-forming substrate to be heated. The cavity may comprise an insertion opening through which the aerosol-forming substrate or an aerosol-generating article may be inserted into the cavity. As used herein, the direction in which the aerosol-forming substrate or the aerosol-generating article is inserted is denoted as insertion direction. Preferably, the insertion direction corresponds to the extension of a length axis, in particular a center axis of the cavity.

Upon insertion into the cavity, at least a portion of the aerosol-forming substrate or the aerosol-generating article may still extend outwards through the insertion opening. The outwardly extending portion of the aerosol-generating article preferably is provided for interaction with a user, in particular for being taken into a user’s mouth. Hence, during use of the device, the insertion opening may be close to the mouth. Accordingly, as used herein, sections close to the insertion opening or close to a user’s mouth in use of the device, respectively, are denoted with the prefix “proximal”. Sections which are arranged further away are denoted with the prefix “distal”.

The cavity may have any suitable cross-section as seen in a plane perpendicular to a length axis of the cavity or perpendicular to an insertion direction of the article. In particular, the cross-section of the cavity may correspond to the shape of the aerosol-generating article to be received therein. Preferably, the cavity has a substantially circular cross-section. Alternatively, the cavity may have a substantially elliptical cross-section or a substantially oval cross-section or a substantially square cross-section or a substantially rectangular cross-section or a substantially triangular cross-section or a substantially polygonal cross-section.

The electrical heating arrangement may be an inductive heating arrangement for inductively heating the aerosol-forming substrate. The inductive heating arrangement may comprise an induction source including an induction coil for generating a varying, in particular an alternating magnetic field. The varying magnetic field preferably is generated at the place of the aerosol-forming substrate in use of the device, in particular within a cavity as described further above. The varying magnetic field may be high-frequency varying magnetic field. The varying magnetic field may be in the range between 500 kHz (kilo-Hertz) to 30 MHz (Mega-Hertz), in particular between 5 MHz to 15 MHz, preferably between 5 MHz and 10 MHz. The varying magnetic field is used to inductively heat a susceptor due to at least one of Eddy currents or hysteresis losses, depending on the electrical and magnetic properties of the susceptor material. In use, the susceptor is in thermal contact with or thermal proximity to the aerosol-forming substrate to be heated, when the aerosol-forming substrate or an aerosol-generating article comprising the substrate is received by the device, in particular in the cavity of the device. In general, the susceptor may be either part of the aerosol-generating device or part of the aerosol-generating article comprising the aerosol-forming substrate to be heated.

The at least one induction coil may be a helical coil or flat planar coil, in particular a pancake coil or a curved planar coil. The at least one induction coil may be held within one of a main body or a housing of the aerosol-generating device. The induction coil may be arranged such as to surround at least a portion of a cavity of the device or at least a portion of the inner surface of such a cavity, respectively. For example, the induction coil may be an induction coil a helical coil, arranged within a side wall of the cavity.

The induction source may comprise an alternating current (AC) generator. The AC generator may be powered by a power supply of the aerosol-generating device. The AC generator is operatively coupled to the at least one induction coil. In particular, the at least one induction coil may be integral part of the AC generator. The AC generator is configured to generate a high frequency oscillating current to be passed through the at least one induction coil for generating an alternating magnetic field. The AC current may be supplied to the at least one induction coil continuously following activation of the system or may be supplied intermittently, such as on a puff by puff basis.

Preferably, the induction source comprises a DC/AC converter connected to the DC power supply including an LC network, wherein the LC network comprises a series connection of a capacitor and the inductor. In addition, the induction source may comprise a matching network for impedance matching. In particular, the induction source comprise may comprise a power amplifier, for example a Class-C power amplifier or a Class-D power amplifier or Class-E power amplifier.

In case of an inductively heating aerosol-generating device, the aerosol-generating device may further comprise a flux concentrator arranged around at least a portion of the induction coil and configured to distort the alternating magnetic field of the at least one inductive source towards cavity. Thus, when the article is received in the cavity, the alternating magnetic field is distorted towards the inductively heatable liquid conduit, if present. Preferably, the flux concentrator comprises a flux concentrator foil, in particular a multi-layer flux concentrator foil.

It is also possible that the electrical heating arrangement may be a resistive heating arrangement for resistively heating the aerosol-forming substrate. In this configuration, the heating element may comprise a resistive heating element. The resistive heating element may be, for example, a resistive heating wire or a resistive heating coil or a resistive heating track (in particular a resistive heating track provided a heating blade), a resistive heating grid or a resistive heating mesh. In use of the device, the resistive heating element is in thermal contact with or thermal proximity to the aerosol-forming substrate to be heated.

The heating arrangement may be configured to modify at least one of the first temperature level or the second temperature level based on environmental data. The environmental data may comprise, for example, the humidity in the environment of the device or the temperature in the environment of the device. Humidity may possibly influence condensation effects in the device, in particular in the immediate vicinity of the aerosol-forming substrate during use of the device. Likewise, the temperature in the environment of the device may influence the aerosol formation and the release.

To record such environmental data, the aerosol-generating device may further comprise at least one environmental data sensor. In particular, the aerosol-generating device may comprise at least one of a humidity sensor for measuring the humidity in the environment of the device or a temperature sensor for measuring the temperature in the environment of the device.

The aerosol-generating device may comprise a power supply, in particular a DC power supply configured to provide a DC supply voltage and a DC supply current to the induction source. Preferably, the power supply is a battery such as a lithium iron phosphate battery. As an alternative, the power supply may be another form of charge storage device such as a capacitor. The power supply may require recharging, that is, the power supply may be rechargeable. The power supply may have a capacity that allows for the storage of enough energy for one or more user experiences. For example, the power supply may have sufficient capacity to allow for the continuous generation of aerosol for a period of around six minutes or for a period that is a multiple of six minutes. In another example, the power supply may have sufficient capacity to allow for a predetermined number of puffs or discrete activations of the induction source.

The aerosol-generating device may comprise a main body which preferably includes at least one of the heating arrangement, the controller, the power supply and at least a portion of the cavity, as far as present. In addition to the main body, the aerosol-generating device may further comprise a mouthpiece, in particular in case the aerosol-generating article to be used with the device does not comprise a mouthpiece. The mouthpiece may be mounted to the main body of the device. As used herein, the term “mouthpiece” refers to a portion of the article through which the aerosol exits the device. The mouthpiece may be configured to close the receiving cavity upon mounting the mouthpiece to the main body. In case the device does not comprise a mouthpiece, an aerosol-generating article to be used with the aerosol-generating device may comprise a mouthpiece, for example a filter plug.

The aerosol-generating device may comprise at least one air outlet, for example, an air outlet in the mouthpiece (if present).

Preferably, the aerosol-generating device comprises an air path extending from the at least one air inlet through the cavity, and possibly further to an air outlet in the mouthpiece, if present. Preferably, the aerosol-generating device comprises at least one air inlet in fluid communication with the cavity. Accordingly, the aerosol-generating system may comprise an air path extending from the at least one air inlet into the cavity, and possibly further through the aerosol-forming substrate within the article and a mouthpiece into a user’s mouth.

Preferably, the aerosol-generating device is a puffing device for generating an aerosol that is directly inhalable by a user thorough the user’s mouth. In particular, the aerosol-generating device is a hand-held aerosol-generating device.

According to the present invention, there is also provided an aerosol-generating system which comprises an aerosol-generating device according to the present invention and as described herein and an aerosol-generating article for use with the device, wherein the article comprises the aerosol-forming substrate to be heated by the device.

As used herein, the term “aerosol-generating system” refers to the combination of an aerosol-generating article as further described herein and an aerosol-generating device according to the invention and as described herein. In the system, the article and the device may cooperate to generate an inhalable aerosol. As already described further above, the term “aerosol-generating article” refers to an article comprising at least one aerosol-forming substrate that, when heated, releases volatile compounds that can form an aerosol. Preferably, the aerosol-generating article is a heated aerosol-generating article. That is, an aerosol-generating article which comprises at least one aerosol-forming substrate that is intended to be heated rather than combusted in order to release volatile compounds that can form an aerosol. The aerosol-generating article may be a consumable, in particular a consumable to be discarded after a single use. For example, the article may be a cartridge including a liquid aerosol-forming substrate to be heated. As another example, the article may be a rod-shaped article, in particular a tobacco article, resembling conventional cigarettes.

As already described further above, the second temperature level preferably is chosen to maintain a usability of the aerosol-releasing substrate for a prolonged time, more particularly by reducing the formation of aerosols by at least 50 percent and/or by avoiding condensation of substances in the aerosol-forming substrate.

In case the aerosol-generating device comprises an inductive heating arrangement, the aerosol-generating system may comprise at least one susceptor for inductively heating the aerosol-forming substrate. The susceptor may be integral part of the aerosol-generating article. Accordingly, the aerosol-generating article may comprise at least one susceptor positioned in thermal proximity to or thermal contact with the aerosol-forming substrate such that in use the susceptor is inductively heatable by the inductive heating arrangement when the article is received in the cavity of the device. It is also possible that the susceptor is part of the aerosol-generating device. Likewise, in this configuration, the susceptor is arranged in the device such that it is in thermal proximity to or thermal contact with the aerosol-forming substrate, when the article is received in the cavity of the device.

The article may comprise one or more of the following elements: a first support element, a substrate element, a second support element, a cooling element, and a filter element. Preferably, the aerosol-generating article comprises at least a first support element, a second support element and a substrate element located between the first support element and the second support element.

The substrate element preferably comprise the at least one aerosol-forming substrate to be heated. In case the aerosol-generating system is based on induction heating, the substrate element may further comprise a susceptor which is in thermal contact with or thermal proximity to the aerosol-forming substrate.

As used herein, the term “susceptor” refers to an element comprising a material that is capable of being inductively heated within an alternating electromagnetic field. This may be the result of at least one of hysteresis losses or Eddy currents induced in the susceptor, depending on the electrical and magnetic properties of the susceptor material.

At least one of the first support element and the second support element may comprise a central air passage. Preferably, at least one of the first support element and the second support element may comprise a hollow cellulose acetate tube. Alternatively, the first support element may be used to cover and protect the distal front end of the substrate element.

The aerosol-cooling element is an element having a large surface area and a low resistance to draw, for example 15 mmWG to 20 mmWG. In use, an aerosol formed by volatile compounds released from the substrate element is drawn through the aerosol-cooling element before being transported to the proximal end of the aerosol-generating article.

The filter element preferably serves as a mouthpiece, or as part of a mouthpiece together with the aerosol-cooling element. As used herein, the term “mouthpiece” refers to a portion of the article through which the aerosol exits the aerosol-generating article.

All of the aforementioned elements may be sequentially arranged along a length axis of the article in the above described order, wherein the first support element preferably is arranged at a distal end of the article and the filter element preferably is arranged at a proximal end of the article. Each of the aforementioned elements may be substantially cylindrical. In particular, all elements may have the same outer cross-sectional shape. In addition, the elements may be circumscribed by an outer wrapper such as to keep the elements together and to maintain the desired cross-sectional shape of the rod-shaped article. Preferably, the wrapper is made of paper.

Further features and advantages of the aerosol-generating system according to the invention have been described with regard to the aerosol-generating device and equally apply.

According to the present invention, there is provided a method of operating an aerosol-generating device or an aerosol-delivery system according to the present invention and as described herein. The method comprises
heating the aerosol-forming substrate at a first temperature level in an aerosol-releasing mode, and
in response to a pause signal, heating the aerosol-forming substrate at a second temperature level below the first temperature level in a pause mode.

As described further above with regard to the aerosol-generating device according to the present invention, the second temperature level preferably is chosen such as to be sufficiently low in order to minimize depletion of the substrate during the pause mode, and at the same time to be sufficiently high in order to avoid vapor to condensate in the device which otherwise could affect the quality of the non-depleted aerosol-forming substrate.

Accordingly, the second temperature level may be at least 150 degree C, in particular at least 175 degree C, preferably at least 185 degree C, more preferably at least 195 degree C. Vice versa, the second temperature level may be at most 220 degree C, in particular at most 225 degree C, preferably at most 215 degree C, more preferably at least 205 degree C. Likewise, the second temperature level preferably is in a range between 175 degree C and 225 degree C, particularly between 185 degree C to 215 degree C, more particularly between 195 degree C and 205 degree C.

In relative terms, the second temperature level may be lower than the first temperature level by at least 50 degree C, in particular at least 75 degree C, more particularly at least 100 degree C.

The first temperature level may be in a range between 325 degree C and 385 degree C, particularly between 340 degree C and 370 degree C, more particularly between 350 degree C and 360 degree C.

The method may further comprise heating the aerosol-forming substrate to return to the first temperature level after elapse of a predetermined maximum pause time or in response to an activity signal. As described further above with regard to the aerosol-generating device according to the present invention, the predetermined maximum pause time may be in a range between 1 minute to 15 minutes, in particular between 2 minutes and 14 minutes, more particularly between 3 minutes and 5 minutes or between 7 minutes and 12 minutes.

As also described further above with regard to the aerosol-generating device according to the present invention, the method may further comprise stopping heating after at least one of
a predetermined number of puffs,
elapse of a predetermined operation time in the aerosol-releasing mode,
elapse of a predetermined operation time in the pause mode; or
elapse of a predetermined weighted cumulative operation time in the aerosol-releasing mode and the pause mode.

In order to change from the aerosol-releasing mode to the pause mode in response to a pause signal heating may be stopped until the second temperature level is reached, followed by heating the aerosol-forming substrate at the second temperature level. Likewise, in response to a pause signal, the aerosol-forming substrate may be heated with reduced heating power or in a pulsed mode until the second temperature level is reached, followed by heating the aerosol-forming substrate at the second temperature level. The change from heating at the first temperature level in the aerosol-releasing mode to heating at the second temperature level in the pause mode in response to the pause signal may also be denoted as cooling mode.

Further features and advantages of the method according to the invention have been described with regard to the aerosol-generating device and the aerosol-generating system and equally apply.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating device comprising an electrical heating arrangement for heating an aerosol-forming substrate in order to generate an aerosol, the heating arrangement being configured to heat the aerosol-forming substrate at a first temperature level in an aerosol-releasing mode, and in response to a pause signal to heat the aerosol-forming substrate at a second temperature level below the first temperature level in a pause mode.

Example Ex2: The aerosol-generating device according to example Ex1, wherein the first temperature level is in a range between 325 degree C and 385 degree C, particularly between 340 degree C and 370 degree C, more particularly between 350 degree C and 360 degree C.

Example Ex3: The aerosol-generating device according to any of the preceding examples, wherein the second temperature level is in a range between 175 degree C and 225 degree C, particularly between 185 degree C to 215 degree C, more particularly between 195 degree C and 205 degree C.

Example Ex4: The aerosol-generating device according to any one of the preceding examples, wherein the second temperature level is lower than the first temperature level by at least 50 degree C, in particular at least 75 degree C, more particularly at least 100 degree C.

Example Ex5: The aerosol-generating device according to any one of the preceding examples, wherein the second temperature level is at least 150 degree C, in particular at least 175 degree C, preferably at least 185 degree C, more preferably at least 195 degree C.

Example Ex6: The aerosol-generating device according to any one of the preceding examples, wherein the second temperature level is at most 220 degree C, in particular at most 225 degree C, preferably at most 215 degree C, more preferably at least 205 degree C.

Example Ex7: The aerosol-generating device according to any one of the preceding examples, further comprising at least one sensor configured to output a sensor signal indicative of the device being in operation by a user or in an operation pause.

Example Ex8: The aerosol-generating device according to example Ex7, wherein the at least one senor comprises one of a puff sensor for detecting a user’s puff, a motion sensor for detecting a movement of the device, and an orientation sensor for detecting an orientation of the device.

Example Ex9: The aerosol-generating device according to any one of the preceding examples, further comprising a user switch enabling a user of the device to initiate at least one of operation of the device or an operation pause.

Example Ex10: The aerosol-generating device according to any one of examples Ex7 to Ex9, further comprising a controller configured to generate the pause signal in response to the sensor signal indicating an operation pause and/or in response to a user initiating an operation pause via the user switch.

Example Ex11: The aerosol-generating device according to example Ex10, wherein the controller is configured to generate an activity signal in response to the sensor signal indicating operation of the device and/or in response to a user initiating operation of the device via the user switch.

Example Ex12: The aerosol-generating device according to any of the preceding examples, wherein the heating arrangement is configured to change from the pause mode to the aerosol-releasing mode after elapse of a predetermined maximum pause time or in response to the activity signal.

Example Ex13: The aerosol-generating device according to example Ex12, wherein the predetermined maximum pause time is in a range between 1 minute to 15 minutes, in particular between 2 minutes and 14 minutes, more particularly between 3 minutes and 5 minutes or between 7 minutes and 12 minutes.

Example Ex14: The aerosol-generating device according to any of the preceding examples, wherein the heating arrangement is configured to stop heating operation after at least one of
a predetermined number of puffs,
elapse of a predetermined operation time in the aerosol-releasing mode,
elapse of a predetermined operation time in the pause mode; or
elapse of a predetermined weighted cumulative operation time in the aerosol-releasing mode and the pause mode.

Example Ex15: The aerosol-generating device according to example Ex14, wherein the predetermined operation time in the aerosol-releasing mode is in a range between 1 minute to 12 minutes, in particular between 2 minutes and 10 minutes, more particularly between 3 minutes and 8 minutes, for example 6 minutes.

Example Ex16: The aerosol-generating device according to any one of example Ex14 or Ex15, wherein the predetermined operation time in the pause mode is in a range between 1 minute to 15 minutes, in particular between 2 minutes and 14 minutes, more particularly between 5 minutes and 13 minutes, for example 12 minutes.

Example Ex17: The aerosol-generating device according to any one of example Ex14 to Ex16, wherein the predetermined weighted cumulative operation time in the aerosol-releasing mode and the pause mode may be in a range between 1 minute to 12 minutes, in particular between 2 minutes and 10 minutes, more particularly between 3 minutes and 8 minutes, for example 6 minutes.

Example Ex18: The aerosol-generating device according to any of the preceding examples, wherein the heating arrangement is configured to change from heating at the first temperature level in the aerosol-releasing mode to heating at the second temperature level in the pause mode in response to the pause signal by stopping heating the aerosol-forming substrate until the second temperature level is reached or by heating the aerosol-forming substrate with reduced heating power or in a pulsed mode until the second temperature level is reached.

Example Ex19: The aerosol-generating device according to any of the preceding examples, wherein the heating arrangement is a resistive heating arrangement or an inductive heating arrangement.

Example Ex20: The aerosol-generating device according to any of the preceding examples, wherein the heating arrangement is configured to modify at least one of the first temperature level or the second temperature level based on environmental data.

Example Ex21: The aerosol-generating device according to any of the preceding examples, further comprising an environmental data sensor, in particular at least one of a humidity sensor for measuring the humidity in the environment of the device or a temperature sensor for measuring the temperature in the environment of the device.

Example Ex22: The aerosol-generating device according to any of the preceding examples, further comprising a user interface, in particular a display or one or more light sources, such as one or more LEDs (Light Emitting Diodes).

Example Ex23: An aerosol-generating system comprising an aerosol-generating device according to any of the preceding examples and an aerosol-generating article for use with the device, the article comprising the aerosol-forming substrate to be heated.

Example Ex24: The aerosol-generating system according to example Ex23, wherein the second temperature level is chosen to maintain a usability of the aerosol-releasing substrate for a prolonged time, more particularly by reducing the formation of aerosols by at least 50 percent and/or by avoiding condensation of substances in the aerosol-forming substrate.

Example Ex25: A method of operating an aerosol-generating device according to any of examples Ex1 to Ex22 or an aerosol-delivery system according to any of examples Ex23 to Ex24, the method comprising:
heating the aerosol-forming substrate at a first temperature level in an aerosol-releasing mode, and
in response to a pause signal, heating the aerosol-forming substrate at a second temperature level below the first temperature level in a pause mode.

Example Ex26: The method according to example Ex25, further comprising heating the aerosol-forming substrate to return to the first temperature level after elapse of a predetermined maximum pause time or in response to an activity signal.

Example Ex27: The method according to example Ex26, wherein the predetermined maximum pause time is in a range between 1 minute to 15 minutes, in particular between 2 minutes and 14 minutes, more particularly between 3 minutes and 5 minutes or between 7 minutes and 12 minutes.

Example Ex28: The method according to any one of examples Ex25 to Ex27, further comprising stopping heating after at least one of
a predetermined number of puffs,
elapse of a predetermined operation time in the aerosol-releasing mode,
elapse of a predetermined operation time in the pause mode; or
elapse of a predetermined weighted cumulative operation time in the aerosol-releasing mode and the pause mode.

Example Ex29: The method according to example Ex28, wherein the predetermined operation time in the aerosol-releasing mode is in a range between 1 minute to 12 minutes, in particular between 2 minutes and 10 minutes, more particularly between 3 minutes and 8 minutes, for example 6 minutes.

Example Ex30: The method according to any one of example Ex28 or Ex29, wherein the predetermined operation time in the pause mode is in a range between 1 minute to 15 minutes, in particular between 2 minutes and 14 minutes, more particularly between 5 minutes and 13 minutes, for example 12 minutes.

Example Ex31: The method according to any one of example Ex28 to Ex30, wherein the predetermined weighted cumulative operation time in the aerosol-releasing mode and the pause mode may be in a range between 1 minute to 12 minutes, in particular between 2 minutes and 10 minutes, more particularly between 3 minutes and 8 minutes, for example 6 minutes.

Example Ex32: The method according to any one of examples Ex25 to Ex31, wherein in response to a pause signal heating is stopped until the second temperature level is reached, followed by heating the aerosol-forming substrate at the second temperature level.

Example Ex33: The method according to any one of examples Ex25 to Ex31, wherein in response to a pause signal the aerosol-forming substrate is heated with reduced heating power or in a pulsed mode until the second temperature level is reached, followed by heating the aerosol-forming substrate at the second temperature level.

Example Ex34: The method according to any one of examples Ex25 to Ex33, wherein the first temperature level is in a range between 325 degree C and 385 degree C, particularly between 340 degree C and 370 degree C, more particularly between 350 degree C and 360 degree C.

Example Ex35: The method according to any one of examples Ex25 to Ex34, wherein the second temperature level is in a range between 175 degree C and 225 degree C, particularly between 185 degree C to 215 degree C, more particularly between 195 degree C and 205 degree C.

Example Ex36: The method according to any one of examples Ex25 to Ex35, wherein the second temperature level is lower than the first temperature level by at least 50 degree C, in particular at least 75 degree C, more particularly at least 100 degree C.

Example Ex37: The method according to any one of examples Ex25 to Ex36, wherein the second temperature level is at least 150 degree C, in particular at least 175 degree C, preferably at least 185 degree C, more preferably at least 195 degree C.

Example Ex38: The method according to any one of examples Ex25 to Ex37, wherein the second temperature level is at most 220 degree C, in particular at most 225 degree C, preferably at most 215 degree C, more preferably at least 205 degree C.

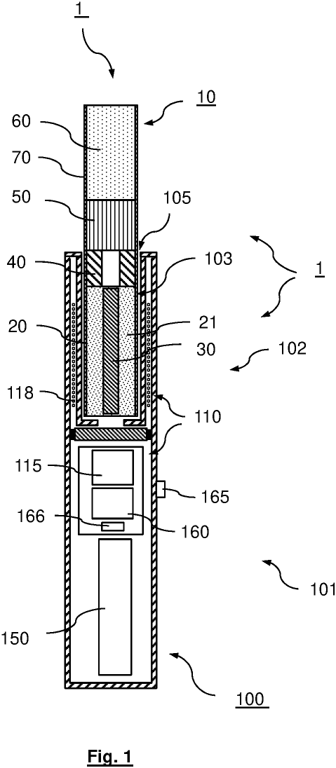

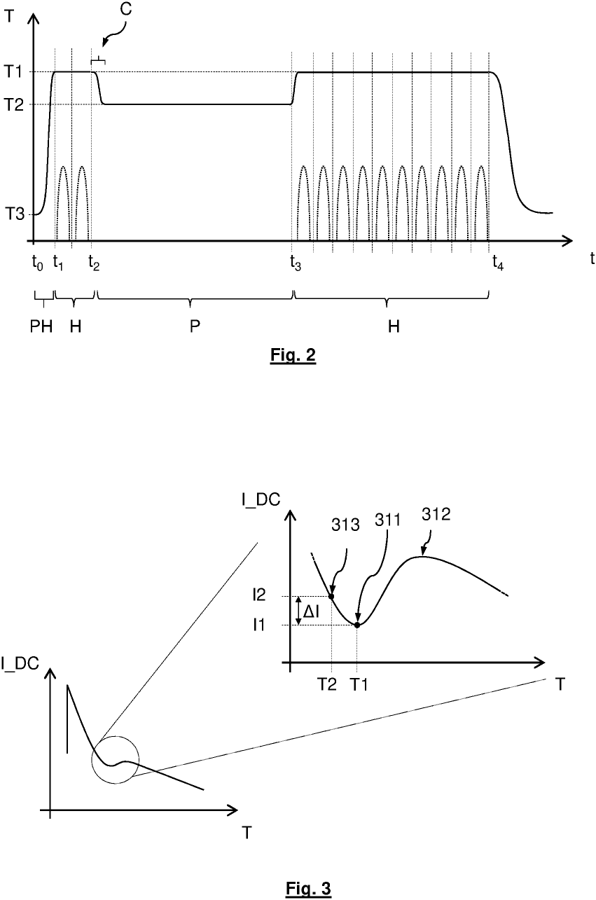

Examples will now be further described with reference to the figures in which:
FIG. 1 schematically illustrates an aerosol-generating system according to an exemplary embodiment of the present invention, including an aerosol-generating device and an aerosol-generating article for use with the device;
FIG. 2 shows an exemplary embodiment of a method for operating the aerosol-generating device according to FIG. 1; and
FIG. 3 shows an electrical current-versus-temperature profile of the aerosol-generating device according to FIG. 1.

FIG. 1 schematically illustrates an exemplary embodiment of an aerosol-generating system 1 according to the present invention that is capable to generate an inhalable aerosol by heating an aerosol-forming substrate. The system 1 comprises an aerosol-generating article 10 which includes the aerosol-forming substrate 21 to be heated, and an aerosol-generating device 100 for inductively heating the substrate upon engaging the article 10 with the device 100.

The aerosol-generating article 10 has a substantially rod-shape resembling the shape of a conventional cigarette. In the present embodiment, the article 10 comprises four elements sequentially arranged in coaxial alignment: a substrate element 20 arranged at a distal end of the article 10, a support element 40 with a central air passage, an aerosol-cooling element 50, and a filter element 60 arranged at a proximal end of the article 10 which serves as a mouthpiece. The substrate element 20 comprises the aerosol-forming substrate 21 to be heated as well as a susceptor 30 which is in direct physical contact with substrate 21 and used to inductively heat the substrate 21. This will be described in more detail below. The four elements have a substantially cylindrical shape with substantially the same diameter. In addition, the four elements are circumscribed by an outer wrapper 70 such as to keep the elements together and to maintain the desired circular cross-sectional shape of the article 10. The wrapper 70 preferably is made of paper. Further details of the article 10, in particular of the four elements, are disclosed, for example, in WO 2015/176898 A1.

The elongate aerosol-generating device 100 comprises two portions: a proximal portion 102 and a distal portion 101. In the proximal portion 102, the device 100 comprises a cavity 103 for removably receiving at least a portion of the aerosol-generating article 10. In the distal portion 101, the device 100 comprises a DC power supply 150, such as a rechargeable battery, for powering operation of the device, as well as a controller 160 for controlling operation of the device 100. For heating the substrate 21 in the article 10, the device 100 comprises an electrical heating arrangement 110 operatively coupled to the controller 160. In the present embodiment, the heating arrangement 110 is an inductive heating arrangement including an electrical circuitry 115 and an induction coil 118 for generating an alternating, in particular high-frequency magnetic field within the cavity 103. As can be seen in FIG. 1, the induction coil 118 is a helical coil which is arranged in the proximal portion 102 of the device such as to circumferentially surround the cylindrical receiving cavity 103. Due to this, the susceptor 30 of the aerosol-generating article 10 experiences the electromagnetic field upon engaging the article 10 with the device 100, thus, allowing to inductively heat the susceptor 30 within the article 10. Accordingly, upon inserting the article 10 into the cavity 103 of the device 100 (as shown in FIG. 1) and activating the heating arrangement 110, the alternating electromagnetic field within the cavity 103 induces Eddy currents and/or hysteresis losses in the susceptor 30, depending on the magnetic and electric properties of the susceptor material. As a consequence, the susceptor 30 heats up until reaching a temperature sufficient to vaporize the aerosol-forming substrate 21 surrounding the susceptor 30 within the article 10.

In use of the system, when a user takes a puff, that is, when a negative pressure is applied at the filter element 60 of the article 10, air is drawn into the cavity 103 at the rim of the article insertion opening 105. The air flow further extends towards the distal end of the cavity 103 through a passage which is formed between the inner surface of the cylindrical cavity 103 and the outer surface of the article 10. At the distal end of the cavity 103, the air flow enters the aerosol-generating article 10 through the substrate element 20. From there, the airflow further passes through the support element 40, the aerosol cooling element 50 and the filter element 60 where it finally exits the article 10. During heating, vaporized material from the aerosol-forming substrate 21 is entrained into the air flow through the substrate element 20. When further passing through the support element 40, the cooling element 50 and the filter element 60 the air flow including the vaporized material cools down such as to form an aerosol escaping the article 10 through the filter element 60.

Normally, once started, a user experience is continued without ceasing until the aerosol-forming substrate in the article is depleted or until predetermined operational conditions are entered. That is, a user typically takes a plurality of consecutive puffs until sensing depletion of the substrate or until a predetermined number of puffs or a predetermined maximum operation time is reached. However, as described further above, there is a longstanding desire to allow a user to interrupt a user experience and to resume the experience at a later stage using the same article with still acceptable quality of the aerosol.

For this, the present invention suggests to interrupt aerosol generation by changing operation of the device 100 from an aerosol-releasing mode to a pause mode in which the aerosol-forming substrate is kept at an intermediate temperature. The intermediate temperature is chosen such as to be below the temperature during the aerosol-releasing mode in order to minimize depletion of the substrate, but still high enough to avoid condensation of vapor in the cavity 103 which might adversely affect the substrate 21. Due to this, a user experience may be interrupted and resumed without sustaining inacceptable quality losses of the aerosol generated after resumption of the user experience.

This procedure is shown in FIG. 2 which illustrates an exemplary embodiment of a method for operating the aerosol-generating device according to FIG. 1 at different temperature T during different operational modes over time t. Starting at the left hand side of FIG. 2, a user experience is initiated at time t₀, for example, by a user input via a user switch 165 shown in FIG. 1 or by detecting the insertion of aerosol-generating article 10 into the device 100. Once initiated, the heating arrangement 110 starts to heat up the aerosol-forming substrate 21 in the article 10 during a pre-heating mode PH from room temperature T3 until reaching a first temperature level T1 at time t₁. The first temperature level T1 is sufficient to vaporize the aerosol-forming substrate 21 in order to form an aerosol. Depending on the substrate type, the first temperature level T1 may be in a range between 325 degree C and 385 degree C, particularly between 340 degree C and 370 degree C, more particularly between 350 degree C and 360 degree C. At time t₁, operation of the heating arrangement 110 changes from the pre-heating mode into an aerosol-releasing mode H in which the temperature t of the aerosol-forming substrate 21 is kept at the first temperature level T1. At this point, a user may start to take a certain number of puffs at his or her discretion until he or she might decide to interrupt the user experience. In the example according to FIG. 2, the user takes two puffs (indicated by the doted curved lines) and subsequently decides at time t₂ to interrupt the user experience temporarily. This pause may be initiated, for example, by a user input, preferably again via the user switch 165. Alternatively or in addition, as shown in FIG. 1, the aerosol-generating device 100 may comprise a motion sensor 166 for detecting a movement of the device 100. The motion sensor 166 may, for example, detect that the aerosol-generating device 100 is not moved for certain time which might be indicative of the device 100 being unused, for example, since the device 100 is lying idle on a table. As a consequence, the motion sensor 166 may output a sensor signal indicative of the device 100 being in an operation pause, that is, a use pause. Subsequently, in response to a user initiating an operation pause, that is, a use pause, via the user switch 165 or in response to such a sensor signal, the controller 160 may generate a pause signal which causes the heating arrangement 110 to change from the aerosol-releasing mode into the pause mode P mentioned above. In the pause mode P, the heating arrangement 110 heats the aerosol-forming substrate 21 at a second temperature level T2 which is below the first temperature level T1 in order to minimize depletion of the substrate 21. Yet, the second temperature level T2 is still high enough to prevent vaporized substances in the cavity 103 from condensation. Depending – inter alia – on the specific substrate type and composition, the second temperature level may be in a range between 175 degree Celsius and 225 degree Celsius, particularly between 185 degree Celsius to 215 degree Celsius, more particularly between 195 degree Celsius and 205 degree Celsius.

Preferably, heating of the substrate 21 at the respective temperature levels T1, T2 during the aerosol-releasing mode or the pause mode is controlled in a closed-loop configuration by the controller 160. For this, the controller 160 may be configured to determine from the DC supply voltage of the DC power supply 150 and from the DC current drawn from the DC power supply 150 an apparent ohmic resistance of the susceptor 30 which is indicative of the temperature of the susceptor 30 and, thus, indicative of the temperature of the aerosol-forming substrate 21. It may be preferred that both the DC supply voltage and a DC current drawn from the DC power supply are measured. This may be achieved with a suitable DC voltage sensor and a suitable DC current sensor (not shown in FIG. 1). However, in case of a DC power supply of constant supply voltage, temperature control may only be based on a measurement of the DC current. Details of this control mechanism are disclosed, for example, in WO 2015/177256 A1.

In order to facilitate the temperature control at the first temperature level T1 and the second temperature level T2, the aerosol-generating system 1 according to FIG. 1 may involve a susceptor 30 which comprises at least two different susceptor materials. That is, the susceptor 30 may comprise a first susceptor material that is optimized with regard to heat loss and thus heating efficiency. In addition, the susceptor 30 may comprise a second susceptor material that is used as temperature marker. For this, the second susceptor material is chosen such as to have a Curie temperature corresponding to a predefined operating temperature of the susceptor assembly. That is, in the present embodiment, the Curie temperature of the second susceptor material preferably is chosen at about the first temperature level T1. As the susceptor 30 reaches the Curie temperature of the second susceptor material, the magnetic properties of this material change from ferromagnetic or ferrimagnetic to paramagnetic, accompanied by a temporary change of the apparent resistance or conductance of the susceptor 30. As described above, the DC current drawn from the DC power supply 150 is proportional to the conductance and inversely proportional to the apparent resistance of the susceptor. Hence, by monitoring a corresponding change of the electrical DC current drawn by the inductive heating arrangement 110 it can be detected when the second susceptor material has reached its Curie temperature and, thus, when the predefined operating temperature has been reached. Details of this control mechanism are disclosed, for example, in WO 2015/177294 A1.

The basics of this mechanism are also illustrated in FIG. 3 which shows the electrical DC current I₋DC absorbed by the inductive heating arrangement 110 versus the temperature T of the susceptor 30 and thus the temperature T of the substrate. For controlling the heating process at the first temperature level T1 during the aerosol-releasing mode, the controller 160 may regulate the current I1 to the local minimum 311 or to a point between the local minimum 311 and the local maximum 312 of the current-versus-temperature profile shown in FIG. 3. For this, the current-versus-temperature profile shown in FIG. 3 may be programmed into the controller 160. For controlling the heating process at the second temperature level T2 during the pause mode, the controller 160 may regulate the current I2 to a point 313 which corresponds to the current at the local minimum 311 plus a pre-determined offset value in the descending part of the current-versus-temperature profile on the left side of the local minimum 311, as also shown in FIG. 3. That is, control of the heating temperate at the second temperature level T2 may be based on the principles of an offset control. In order keep the temperature at the respective temperature levels T1, T2 during the aerosol-releasing mode H or during the pause mode P, respectively, the heating arrangement 110 may be operated in pulsed mode. The principles of pulsed mode operation are described, for example, in WO 2015/177256 A1.

For changing the temperature of the substrate 21 from the first temperature level T1 to the second temperature level T2, the heating arrangement 110 might stop heating the aerosol-forming substrate 21 until the second temperature level T2 is reached. Alternatively, the heating arrangement 110 may heat the aerosol-forming substrate 21 with reduced heating power or in a pulsed mode until the second temperature level T2 is reached. The change from heating at the first temperature level T1 in the aerosol-releasing mode H to heating at the second temperature level T2 in the pause mode P may be denoted as cooling mode C. As indicated in FIG. 2, the cooling mode C may be an initial part of the pause mode P.

Upon having reached the second temperature level T2, the heating arrangement 110 may return to a normal heating mode - like during the aerosol-releasing mode H - for keeping the temperature of the substrate 21 at the second temperature T2, in particular by using a feedback control as described above.

Once a user has decided to resume the user experience, a change from the pause mode P back into the aerosol-releasing mode may be initiated, for example, by a user input, preferably via the user switch 165. Accordingly, in response to a user re-initiating operation of the device via the user switch 165, the controller 160 may generate an activity signal which causes the heating arrangement 110 to be operated in the aerosol-heating mode P again by increasing and subsequently keeping the temperature of the susceptor 21 at the first temperature level T1, as shown at time t₃ in FIG. 2.

In addition or alternatively, the motion sensor 166 may be used to re-initiate the aerosol-releasing mode when detecting a movement of the device 100 which might indicate that the user is (again) holding the device 100 and therefore probably about to resume the user experience. When doing so, the motion sensor 166 may output a sensor signal indicative of the device 100 being or being intended to be in operation again. In response to such as a sensor signal, the controller 160 may also generate – like in response to an activation of the user switch – an activity signal which causes the heating arrangement 110 to be operated in the aerosol-heating mode P again by increasing and subsequently keeping the temperature of the susceptor 21 at the first temperature level T1.

It is also possible that the heating arrangement 110 is configured to change from the pause mode P to the aerosol-releasing mode H after elapse of a predetermined maximum pause time, for example, after ten minutes. In particular, this may happen irrespective of whether a user has actively initiated the resumption of the user experience. Advantageously, this avoids keeping the device 100 excessively long in the pause mode which in turn prevents the aerosol-forming substrate 21 from eventually becoming depleted without being used. In addition, having a predetermined maximum pause time may help preventing the device 100 from running out of electrical power.

Despite that, the heating arrangement 110 according to the present embodiment is configured to stop heating operation anyway after a predetermined number of puffs or after elapse of a predetermined weighted cumulative operation time in the aerosol-releasing mode and the pause mode, depending on which event occurs earlier. Using a weighted cumulative operation time advantageously may take into account that the aerosol-forming substrate might get still be slightly depleted during the pause mode which reduces the effective operation time in the aerosol-releasing mode. As an example, the time in aerosol-releasing mode may be weighted with a factor of 1, whereas the time in the pause mode may be weighted with a factor of ⅙. Accordingly, in case the effective operation time of a given aerosol-generating article for realizing a still acceptable amount of aerosol is, for example, 6 minutes, the device may be operated for 6 minutes in the aerosol-releasing mode and for 0 minutes in the pause mode, or for 5 minutes in the aerosol-releasing mode and for 6 minutes in the pause mode, or for 4 minutes in the aerosol-releasing mode and for 12 minutes in the pause mode, and so on. In the present embodiment, heating operation is stopped at time t4 due to having reached a predetermined maximum total number of twelve puffs that are available when using the aerosol-generating article shown in FIG. 1.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ± 5 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1-15. (canceled)

16. An aerosol-generating device, comprising:
an electrical heating arrangement configured to heat an aerosol-forming substrate in order to generate an aerosol;
at least one of a user switch configured to enable a user to initiate a use pause of the aerosol-generating device, and at least one sensor configured to output a sensor signal indicative of the aerosol-generating device being in use by the user or in the use pause; and
a controller configured to generate a pause signal in response to the sensor signal indicating that the aerosol-generating device is in the use pause and/or in response to the user initiating the use pause of the aerosol-generating device via the user switch,
wherein the electrical heating arrangement is further configured to heat the aerosol-forming substrate at a first temperature level in an aerosol-releasing mode, and in response to the pause signal to heat the aerosol-forming substrate at a second temperature level below the first temperature level in a pause mode.

17. The aerosol-generating device according to claim 16, wherein the first temperature level is in a range between 325° C. and 385° C.

18. The aerosol-generating device according to claim 16, wherein the second temperature level is in a range between 175° C. and 225° C.

19. The aerosol-generating device according to claim 16, wherein the second temperature level is lower than the first temperature level by at least 50° C.

20. The aerosol-generating device according to claim 16, wherein the at least one senor comprises one of a puff sensor configured to detect a user’s puff, a motion sensor configured to detect a movement of the aerosol-generating device, and an orientation sensor configured to detect an orientation of the aerosol-generating device.

21. The aerosol-generating device according to claim 16, wherein the user switch is further configured to enable the user to initiate use of the aerosol-generating device.

22. The aerosol-generating device according to claim 21, wherein the controller is further configured to generate an activity signal in response to the sensor signal indicating that the aerosol-generating device is in use by the user and/or in response to the user initiating use of the aerosol-generating device.

23. The aerosol-generating device according to claim 22, wherein the electrical heating arrangement is further configured to change from the pause mode to the aerosol-releasing mode after elapse of a predetermined maximum pause time or in response to the activity signal.

24. The aerosol-generating device according to claim 23, wherein the predetermined maximum pause time is in a range between 1 minute to 15 minutes.

25. The aerosol-generating device according to claim 16, wherein the heating arrangement is further configured to stop a heating operation in both the aerosol-releasing mode and the pause mode after at least one of:
a predetermined number of puffs,
elapse of a predetermined operation time in the aerosol-releasing mode,
elapse of a predetermined operation time in the pause mode, or
elapse of a predetermined weighted cumulative operation time in the aerosol-releasing mode and the pause mode.

26. The aerosol-generating device according to claim 25, wherein the predetermined operation time in the aerosol-releasing mode is in a range between 1 minute to 12 minutes.

27. The aerosol-generating device according to claim 25, wherein the predetermined operation time in the pause mode is in a range between 1 minute to 15 minutes.

28. The aerosol-generating device according to claim 16, wherein the heating arrangement is further configured to change from heating at the first temperature level in the aerosol-releasing mode to heating at the second temperature level in the pause mode in response to the pause signal by stopping heating the aerosol-forming substrate until the second temperature level is reached or by heating the aerosol-forming substrate with reduced heating power or in a pulsed mode until the second temperature level is reached.

29. The aerosol-generating device according to claim 16, wherein the heating arrangement is further configured to modify at least one of the first temperature level or the second temperature level based on environmental data.

30. The aerosol-generating device according to claim 16, further comprising an environmental data sensor configured to measure at least one parameter in an environment of the aerosol-generating device.

31. The aerosol-generating device according to claim 30, wherein the environmental data sensor is at least one of a humidity sensor configured to measure a humidity in the environment of the aerosol-generating device or a temperature sensor configured to measure a temperature in the environment of the aerosol-generating device.
